(19) United States
(12) Patent Application Publication
(10) Pub. No.: US 2026/0037994 A1
(43) Pub. Date: Feb. 5, 2026

(54) PRODUCT DEMAND PREDICTION APPARATUS, NEW PRODUCT DEMAND PREDICTION METHOD, AND RECORDING MEDIUM

(71) Applicant: NEC Corporation, Tokyo (JP)

(72) Inventors: Yudai Yamaguchi, Tokyo (JP); Riki Eto, Tokyo (JP); You Iwakami, Tokyo (JP); Yasuki Misawa, Tokyo (JP)

(73) Assignee: NEC Corporation, Tokyo (JP)

(21) Appl. No.: 19/263,731

(22) Filed: Jul. 9, 2025

(30) Foreign Application Priority Data
Jul. 30, 2024 (JP) 2024-123457

(51) Int. Cl. G06Q 30/0202

(52) U.S. Cl. CPC G06Q 30/0202

(57) ABSTRACT

A new product demand prediction apparatus according to the present disclosure includes: a memory configured to store instructions; and one or more processors configured to execute the instructions to: acquire new product information including at least information regarding promotion of a new product that is a target of demand prediction; acquire first similar product information indicating a sales performance of a first similar product selected based on at least one element of a scale of the promotion, a characteristic of a product, and a sales method; acquire second similar product information indicating a sales performance of a second similar product selected based on the category of the product; and predict sales in a predetermined period including a period after a promotion period of the new product based on the new product information, the first similar product information, and the second similar product information.

This application is based upon and claims the benefit of priority from Japanese Patent Application No. 2024-123457, filed on Jul. 30, 2024, the disclosure of which is incorporated herein in its entirety by reference.

### TECHNICAL FIELD

The present disclosure relates to a new product demand prediction apparatus, a new product demand prediction method, and a recording medium.

### BACKGROUND ART

A technique for performing demand prediction is known. An example of a technique for performing demand prediction is a technique disclosed in WO 2017/163278 A1, for example. WO 2017/163278 A1 discloses, as a technique for improving the accuracy of demand prediction of a product for which learning data does not exist, that a learning device learns a prediction model based on learning data including an elapsed period from a start of sale of the product, a word included in a name of the product, and a demand quantity of the product after the start of sale, and a prediction device predicts a demand quantity of a target product that is a product for which learning data does not exist.

### SUMMARY

an exemplary object of this disclosure is to provide a technology capable of accurately performing long-term demand prediction of a new product that has passed a promotion period.

A new product demand prediction apparatus according to an exemplary aspect of the present disclosure includes a first acquisition unit for acquiring new product information including at least information regarding promotion of a new product that is a target of demand prediction, a second acquisition unit for acquiring first similar product information indicating a sales performance of a first similar product selected based on at least one element of a scale of the promotion, a characteristic of a product, and a sales method, a third acquisition unit for acquiring second similar product information indicating a sales performance of a second similar product selected based on the category of the product, and a prediction unit for predicting sales in a predetermined period including a period after a promotion period of the new product based on the new product information, the first similar product information, and the second similar product information.

A new product demand prediction method according to an exemplary aspect of the present disclosure causes at least one processor to include first acquisition processing for acquiring new product information including at least information regarding promotion of a new product that is a target of demand prediction, second acquisition processing for acquiring first similar product information indicating a sales performance of a first similar product selected based on at least one element of a scale of the promotion, a characteristic of a product, and a sales method, third acquisition processing for acquiring second similar product information indicating a sales performance of a second similar product selected based on the category of the product, and prediction processing for predicting sales in a predetermined period including a period after a promotion period of the new product based on the new product information, the first similar product information, and the second similar product information.

A new product demand prediction program according to an exemplary aspect of the present disclosure, causing a computer to function as a new product demand prediction apparatus, causes the computer to function as first acquisition means for acquiring new product information including at least information regarding promotion of a new product that is a target of demand prediction, second acquisition means for acquiring first similar product information indicating a sales performance of a first similar product selected based on at least one element of a scale of the promotion, a characteristic of a product, and a sales method, third acquisition means for acquiring second similar product information indicating a sales performance of a second similar product selected based on the category of the product, and prediction means for predicting sales in a predetermined period including a period after a promotion period of the new product based on the new product information, the first similar product information, and the second similar product information.

### BRIEF DESCRIPTION OF THE DRAWINGS

Exemplary features and advantages of the present disclosure will become apparent from the following detailed description when taken with the accompanying drawings in which:

FIG. 1 is a block diagram showing a configuration of a new product demand prediction apparatus according to the present disclosure;

FIG. 2 is a flowchart illustrating a flow of a new product demand prediction method according to the present disclosure;

FIG. 3 is a diagram illustrating a configuration of a demand prediction system according to the present disclosure;

FIG. 4 is a block diagram illustrating a configuration of an information processing apparatus according to the present disclosure;

FIG. 5 is a block diagram illustrating a configuration of a user terminal according to the present disclosure;

FIG. 6 is a flowchart illustrating a second example of a flow of a new product demand prediction method according to the present disclosure;

FIG. 7 is a view illustrating an example of a display screen of a prediction result according to the present disclosure;

FIG. 8 is a view illustrating another example of a display screen of a prediction result according to the present disclosure;

FIG. 9 is a sequence diagram illustrating a third example of a flow of a new product demand prediction method according to the present disclosure; and

FIG. 10 is a block diagram illustrating a configuration of a computer that functions as an information processing apparatus according to the present disclosure.

### EXAMPLE EMBODIMENT

Hereinafter, example embodiments of the present disclosure will be described. However, the present disclosure is not limited to the example embodiments to be described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Advantages mentioned in the following example embodiments are examples of advantages expected in the example embodiments, and do not define extensions of the present disclosure. In other words, example embodiments that do not achieve the effects mentioned in the following illustrative example embodiments can also be included in the scope of the present disclosure.

### First Example Embodiment

A first example embodiment that is an example of an example embodiment of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technology illustrated in the drawings referred to for describing the present illustrative example embodiment can also be adopted in other illustrative example embodiments included in the present disclosure within a range in which no particular technical problems occur.

### (Configuration of New Product Demand Prediction Apparatus)

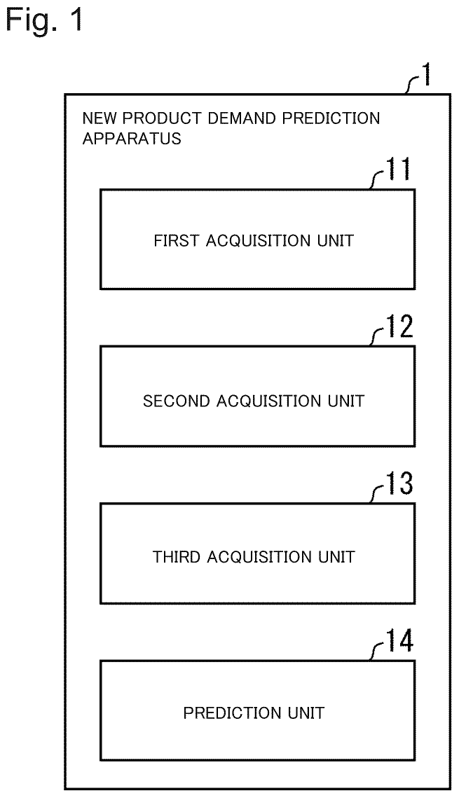

A configuration of a new product demand prediction apparatus 1 will be described with reference to FIG. 1. FIG. 1 is a block diagram showing a configuration of a new product demand prediction apparatus 1. As shown in FIG. 1, the new product demand prediction apparatus 1 includes a first acquisition unit 11, a second acquisition unit 12, a third acquisition unit 13, and a prediction unit 14.

The first acquisition unit 11 acquires new product information including at least information regarding promotion of a new product that is a target of demand prediction. The second acquisition unit 12 acquires first similar product information indicating a sales performance of a first similar product selected based on at least one of a scale of the promotion, characteristics of the product, and a sales method. The third acquisition unit 13 acquires second similar product information indicating sales performance of a second similar product selected based on a category of the product. The prediction unit 14 predicts sales in a predetermined period including a period after a promotion period of the new product based on the new product information, the first similar product information, and the second similar product information.

### (Effects of New Product Demand Prediction Apparatus)

As described above, the new product demand prediction apparatus 1 is configured to include the first acquisition unit 11 for acquiring new product information including at least information regarding promotion of a new product that is a target of demand prediction, the second acquisition unit 12 for acquiring first similar product information indicating a sales performance of a first similar product selected based on at least one element of a scale of the promotion, a characteristic of a product, and a sales method, the third acquisition unit 13 for acquiring second similar product information indicating a sales performance of a second similar product selected based on the category of the product, and the prediction unit 14 for predicting sales in a predetermined period including a period after a promotion period of the new product based on the new product information, the first similar product information, and the second similar product information. Therefore, according to the new product demand prediction apparatus 1, it is possible to accurately perform long-term demand prediction of a new product that has passed the promotion period.

### (Flow of New Product Demand Prediction Method)

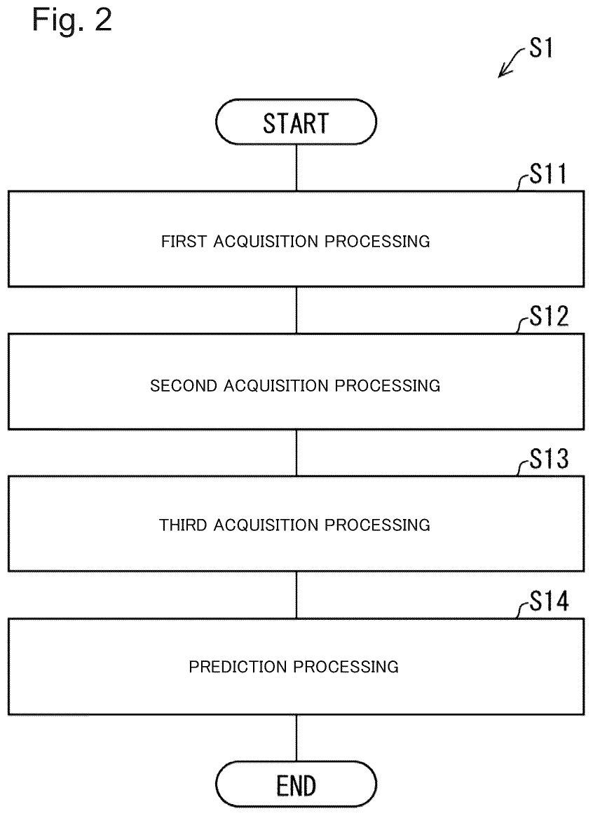

A flow of the new product demand prediction method S1 will be described with reference to FIG. 2. FIG. 2 is a flowchart illustrating a flow of the new product demand prediction method S1. As shown in FIG. 2, the new product demand prediction method S1 includes first acquisition processing S11, second acquisition processing S12, third acquisition processing S13, and prediction processing S14.

In the first acquisition processing S11, at least one processor acquires new product information including at least information on promotion of a new product that is a demand prediction target. In the second acquisition processing S12, at least one processor acquires first similar product information indicating the sales performance of the first similar product selected based on at least one element of the scale of the promotion, the characteristics of the product, and the sales method. In the third acquisition processing S13, at least one processor acquires second similar product information indicating the sales performance of the second similar product selected based on the category of the product. In the prediction processing S14, at least one processor predicts sales in a predetermined period including a period after a promotion period of the new product based on the new product information, the first similar product information, and the second similar product information.

### (Effects of New Product Demand Prediction Method)

As described above, the new product demand prediction method S1 causes at least one processor to include first acquisition processing for acquiring new product information including at least information regarding promotion of a new product that is a target of demand prediction, second acquisition processing for acquiring first similar product information indicating a sales performance of a first similar product selected based on at least one element of a scale of the promotion, a characteristic of a product, and a sales method, third acquisition processing for acquiring second similar product information indicating a sales performance of a second similar product selected based on the category of the product, and prediction processing for predicting sales in a predetermined period including a period after a promotion period of the new product based on the new product information, the first similar product information, and the second similar product information. Therefore, according to the new product demand prediction method S1, it is possible to accurately perform long-term demand prediction of a new product that has passed the promotion period.

### Second Example Embodiment

A second example embodiment that is an example of an example embodiment of the present disclosure will be described in detail with reference to the drawings. Components that have the same functions as the components of the above-described example embodiment are denoted by the same reference numerals, and the description of the constituents will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within a range in which no particular technical problem occurs.

### (Configuration of Demand Prediction System)

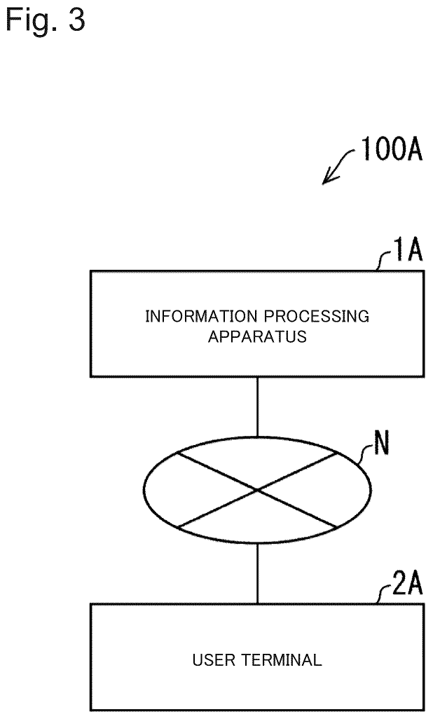

A configuration of a demand prediction system 100A according to the present disclosure will be described with reference to FIG. 3. FIG. 3 is a block diagram illustrating a configuration of the demand prediction system 100A. The demand prediction system 100A is a system that predicts a demand for a product, and includes an information processing apparatus 1A and a user terminal 2A. The information processing apparatus 1A and the user terminal 2A are communicably connected via a communication line N. Although a specific configuration of the communication line N is not limited to the present example embodiment, the communication line Nis, for example, a wireless local area network (LAN), a wired LAN, a wide area network (WAN), a public line network, a mobile data communication network, or a combination thereof.

The information processing apparatus 1A is an apparatus having a function of predicting a demand for a product, and is, for example, a general-purpose server. The information processing apparatus 1A may also be a personal computer such as a laptop personal computer or a tablet terminal. The user terminal 2A is a terminal used by a user (for example, a planner) who uses the service, and is, for example, a personal computer such as a laptop personal computer or a tablet terminal.

### (Configuration of Information Processing Apparatus)

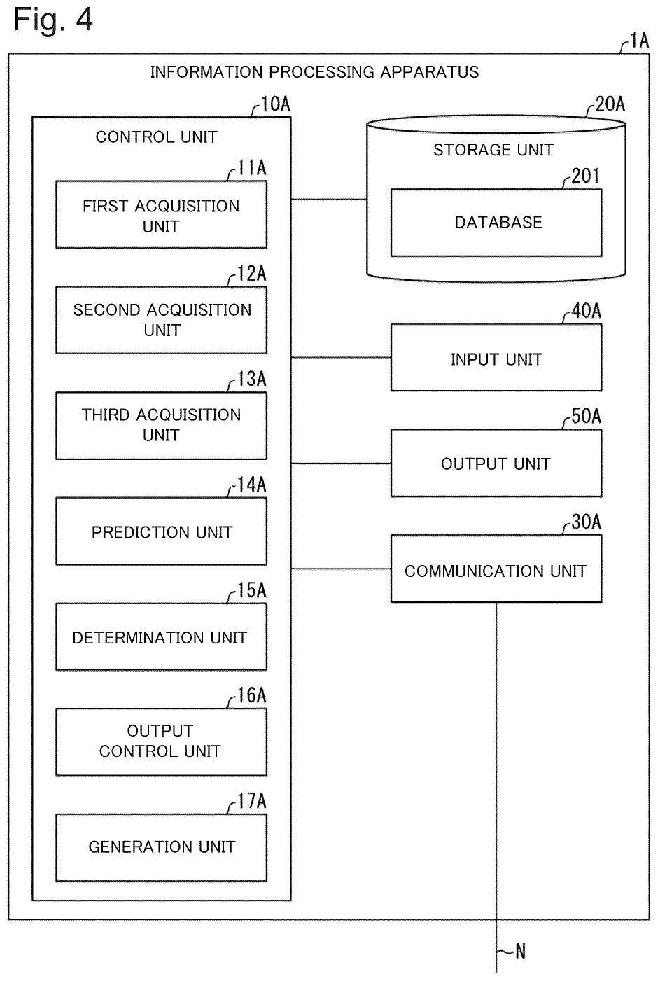

A configuration of the information processing apparatus 1A will be described with reference to FIG. 4. FIG. 4 is a block diagram illustrating a configuration of the information processing apparatus 1A. The information processing apparatus 1A includes a control unit 10A, a storage unit 20A, a communication unit 30A, an input unit 40A, and an output unit 50A. The communication unit 30A communicates with a device (user terminal 2A, etc.) outside the information processing apparatus 1A via a communication line. The communication unit 30A transmits data supplied from the control unit 10A to another device, and supplies data received from another device to the control unit 10A.

### (Input Unit/Output Unit)

The input unit 40A is a configuration for receiving an input to the information processing apparatus 1A, and includes, as an example, an input device such as a keyboard, a mouse, a touch panel, a camera, or a microphone. The input unit 40A may be configured to receive data from the input device via, for example, an interface such as a universal serial bus (USB). The output unit 50A is a configuration for performing output from the information processing apparatus 1A, and includes, as an example, an output device such as a display, a printer, a touch panel, or a speaker. The output unit 50A may include, for example, an interface such as a USB, and may be configured to output data to the output device via the interface.

### (Storage Unit)

The storage unit 20A stores various types of information to be referred to by the control unit 10A. An example of such information is a database 201. The database 201 is a database in which product information on the product for each product is accumulated. The product information includes, for example, (a) product master information, (b) sales channel information, (c) sales performance information, (d) sales month information, (e) marketing information, (f) external environment information, (g) information on characteristics of the product, and the like.

(a) The product master information includes, for example, information indicating a category of a product and information indicating a sales price. The information indicating the category of the product is, for example, information indicating the category of the product such as “drinking water” and “fresh food”. (b) The sales channel information includes, for example, information indicating a type of channel in which a product is sold, information indicating a sales method of the product, and the like. The information indicating the method of selling the product includes, for example, information indicating whether the product is a limited quantity release. (c) The sales performance information is information indicating the sales performance of the product, and includes, as an example, information indicating the sales performance for each unit period (every week, every month). (d) The sales month information is information indicating a sales month of a product.

(e) The marketing information is information regarding marketing of a product, and includes, as an example, information indicating measures for implementing a promotion, a scale of the promotion, a period of the promotion, sales performance during the period of the promotion, and the like. (f) The external environment information at the time of sale includes the external environment at the time of sale (average temperature, number of foreign visitors, etc.). (g) The information on the characteristics of the product includes, for example, information indicating whether it is a refill product, information indicating whether it is a seasonal product, and the like. However, the product information is not limited to the above-described examples, and the product information may include other information related to the product.

The database 201 may store product information on new products. In this case, the product information on the new product does not include information indicating sales performance. In the example of FIG. 4, the case where the database 201 is included in the storage unit 20A of the information processing apparatus 1A has been described, but the database 201 may be included in another apparatus connected to the information processing apparatus 1A via the communication line N. In this case, the information processing apparatus 1A accesses the database 201 by communicating with the other apparatus via the communication line N.

### (Control Unit)

The control unit 10A includes a first acquisition unit 11A, a second acquisition unit 12A, a third acquisition unit 13A, a prediction unit 14A, a determination unit 15A, an output control unit 16A, and a generation unit 17A. The first acquisition unit 11A is an example of first acquisition means according to the present disclosure. The second acquisition unit 12A is an example of second acquisition means according to the present disclosure. The third acquisition unit 13A is an example of third acquisition means according to the present disclosure. The prediction unit 14A is an example of prediction means according to the present disclosure. The determination unit 15A is an example of determination means according to the present disclosure. The output control unit 16A is an example of output control means and presentation means according to the present disclosure.

The generation unit 17A is an example of generation means according to the present disclosure. Each unit of the control unit 10A is achieved by the control unit 10A reading and executing a command of a program stored in the storage unit 20A.

### (First Acquisition Unit)

The first acquisition unit 11A acquires product information (an example of new product information) on a new product that is a target of demand prediction. The product information on the new product acquired by the first acquisition unit 11A includes at least information on promotion of the new product. As an example, the first acquisition unit 11A receives data indicating a user's instruction or selection from the user terminal 2A to receive selection of a new product that is a target of demand prediction, and reads product information on the new product associated with the received selection from the database 201 to acquire the product information. The first acquisition unit 11A may also receive the selection input by the user to the input unit 40A and read product information on a new product associated with the received selection from the database 201. Hereinafter, a new product that is a target of demand prediction is also simply referred to as a “new product”.

The first acquisition unit 11A may receive product information on a new product from another device via communication unit 30A. The first acquisition unit 11A may acquire the product information on the new product input to the input unit 40A. The first acquisition unit 11A may acquire product information on a new product by reading the product information from a storage destination (a storage device in the information processing apparatus 1A or a storage device outside the information processing apparatus 1A may be used) designated by the user of the information processing apparatus 1A.

### (Second Acquisition Unit·Rising Weight Similar Product)

The second acquisition unit 12A acquires the product information on the rising weight similar product selected as the similar product of the new product. The rising weight similar product is a product selected based on at least one of the promotion scale, the product characteristics, and the sales method. The rising weight similar product is an example of a first similar product according to the present disclosure. In the present disclosure, the rising weight indicates a ratio of a sales performance in a promotion target period of rising to a sales performance in a predetermined period (for example, one year) from release. The rising weights of products having similar factors such as the scale of promotion, product characteristics, and sales method often have close values. Using the sales performance of the rising weight similar product selected based on these factors, the prediction unit 14A described later predicts the sales of the new product.

As an example, the second acquisition unit 12A receives data indicating the user's instruction or selection from the user terminal 2A to receive the selection of the rising weight similar product, and reads the product information on the rising weight similar product associated with the received selection from the database 201 to acquire the product information on the rising weight similar product. The second acquisition unit 12A may also receive the selection input by the user to the input unit 40A, and read the product information on the rising weight similar product associated with the received selection from the database 201.

The second acquisition unit 12A may receive the product information on the rising weight similar product from another device via the communication unit 30A. The second acquisition unit 12A may acquire the product information on the rising weight similar product input to the input unit 40A. The second acquisition unit 12A may acquire the product information by reading the product information on the rising weight similar product from a storage destination (a storage device in the information processing apparatus 1A or a storage device outside the information processing apparatus 1A may be used) designated by the user of the information processing apparatus 1A.

The second acquisition unit 12A may select one product or a plurality of products as the rising weight similar product. In other words, the second acquisition unit 12A may acquire the product information on the plurality of rising weight similar products.

### (Third Acquisition Unit·Seasonal Similar Product)

The third acquisition unit 13A acquires product information on a seasonal similar product selected as a similar product of a new product. The seasonal similar product is a product selected based on the category of the product, and is an example of a second similar product according to the present disclosure. Although the demand of a product changes due to various factors such as trends and seasons, a fluctuation pattern of the long-term demand of the product often depends on the category of the product. Using the sales performance of the seasonal similar product selected based on the category of the product, the prediction unit 14A to be described later predicts the sales of the new product.

As an example, the third acquisition unit 13A receives the data indicating the user's instruction or selection from the user terminal 2A to receive the selection of the seasonal similar product, and reads the product information on the seasonal similar product associated with the received selection from the database 201 to acquire the product information on the seasonal similar product. The third acquisition unit 13A may also receive the selection input by the user to the input unit 40A and read the product information on the seasonal similar product associated with the received selection from the database 201.

The third acquisition unit 13A may also receive the product information on the seasonal similar product from another device via the communication unit 30A. The third acquisition unit 13A may acquire the product information on the seasonal similar product input to the input unit 40A. The third acquisition unit 13A may acquire the product information on the seasonal similar product by reading the product information from a storage destination (a storage device in the information processing apparatus 1A or a storage device outside the information processing apparatus 1A may be used) designated by the user of the information processing apparatus 1A.

The third acquisition unit 13A may select one product or a plurality of products as the seasonal similar products. In other words, the third acquisition unit 13A may acquire product information on a plurality of seasonal similar products.

### (Prediction Unit)

The prediction unit 14A predicts the sales of the new product in the predetermined period based on the product information on the new product, the product information on the rising weight similar product, and the product information on the seasonal similar product. Here, the predetermined period is a period (for example, one year after release) including a period after the promotion period of the new product. The promotion period is a target period of promotion of the new product (for example, for several months after release).

As an example, the prediction unit 14A predicts the total value of the sales of the new product in the predetermined period using the sales performance of the new product in the promotion period and the rising weight of the rising weight similar product (ratio of the sales performance in the promotion period to the sales performance in the predetermined period). More specifically, as an example, the prediction unit 14A predicts the total value of the sales of the new product in the predetermined period by dividing the sales performance of the new product in the promotion period by the rising weight of the rising weight similar product.

The prediction unit 14A also predicts the sales of the new product for each unit period in the predetermined period using the total value of the sales and the sales performance of the seasonal similar product for each unit period included in the predetermined period. More specifically, as an example, the prediction unit 14A predicts the sales of the new product for each unit period by multiplying the predicted total value by the ratio of the sales performance for each unit period to the sales performance of the seasonal similar product for a predetermined period.

In a case where a plurality of rising weight similar products is selected, the prediction unit 14A predicts the sales of the new product in the predetermined period using the statistical value of the sales performance for each rising weight similar product. In a case where a plurality of seasonal similar products is selected, the prediction unit 14A predicts the sales of the new product in the predetermined period of the new product based on the statistical value of the sales performance for each of the seasonal similar products. Here, as an example, the statistical value includes, but is not limited to, an average value, a median value, a mode value, a geometric mean, and a root mean square of sales performance of a plurality of products.

### (Output Control Unit)

The output control unit 16A outputs the prediction result of the sales of the new product predicted by the prediction unit 14A. As an example, the output control unit 16A outputs data indicating a prediction result of sales to a display, and the display the prediction result on the display. The display is, for example, a display of the user terminal 2A. In this case, the output control unit 16A transmits data indicating the prediction result to the user terminal 2A via the communication unit 30A, and displays the screen on the display of the user terminal 2A. In the present specification, that the output control unit 16A transmits data indicating a prediction result to the user terminal 2A and causes the prediction result to be displayed on the display of the user terminal 2A is also referred to as “the output control unit 16A displays the prediction result”.

The output control unit 16A may cause the display connected to the output unit 50A to display the prediction result by outputting data indicating the prediction result to the display. The output control unit 16A may also write and output the data to a storage destination (a storage device in the information processing apparatus 1A or a storage device outside the information processing apparatus 1A may be used) designated by the user of the information processing apparatus 1A. The output control unit 16A may transmit the data to another device via the communication unit 30A, or may output the data to an output device such as a speaker or a printer.

### (Determination Unit)

The determination unit 15A determines the rising weight similar product and the seasonal similar product, or a product to be a candidate for the rising weight similar product and the seasonal similar product. As an example, the determination unit 15A refers to the database 201 and determines a product whose at least one element of the promotion scale, the product characteristics, and the sales method is the same as or similar to the new product as a candidate for a rising weight similar product or a rising similar product. As an example, the determination unit 15A may refer to the database 201 to determine a product belonging to a product category of a new product as a candidate for a seasonal similar product or a seasonal similar product.

The determination unit 15A may also determine the optimum solution in the selection of the rising weight similar product and the seasonal similar product by using the objective function generated in advance by the inverse reinforcement learning based on the decision-making history related to the selection of the rising weight similar product and the seasonal similar product and the product information on the new product acquired by the first acquisition unit 11A. Details of the processing in which the determination unit 15A determines the optimal solution using the objective function will be described later.

In a case where the determination unit 15A determines the optimum solution, the second acquisition unit 12A acquires the product information on the rising weight similar product based on the optimum solution determined by the determination unit 15A. The third acquisition unit 13A acquires the product information on the seasonal similar product based on the optimum solution determined by the determination unit 15A.

In this case, the output control unit 16A may present a plurality of candidates for the rising weight similar product and a plurality of candidates for the seasonal similar product to the user based on the optimum solution determined by the determination unit 15A. In this case, the second acquisition unit 12A acquires the product information on the rising weight similar product selected from the plurality of candidates for the rising weight similar product based on the user operation. The third acquisition unit 13A acquires the product information on the seasonal similar product selected from the plurality of candidates for the seasonal similar product based on the user operation.

### (Generation Unit)

The generation unit 17A generates the objective function referred to by the determination unit 15A by the inverse reinforcement learning based on the decision-making history regarding the selection of the rising weight similar product and the seasonal similar product. Details of processing in which the generation unit 17A generates the objective function will be described later. Hereinafter, in a case where it is not necessary to distinguish the rising weight similar product and the seasonal similar product from each other, these are simply referred to as “similar products”.

### (Configuration of User Terminal)

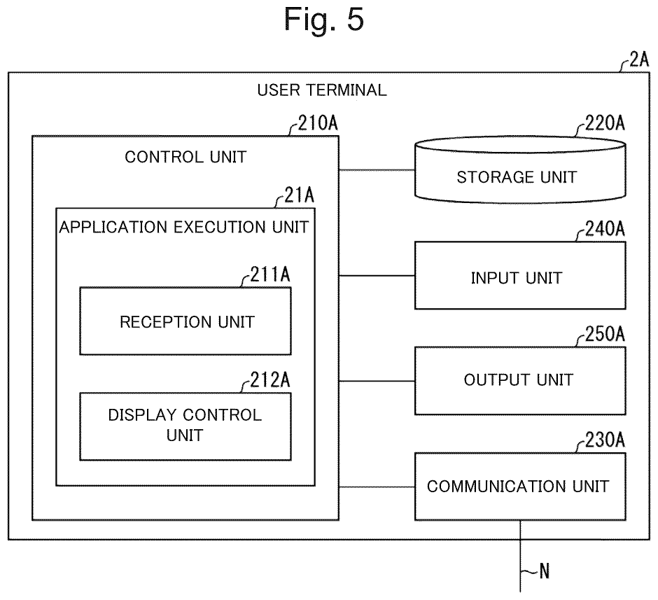

FIG. 5 is a block diagram illustrating a configuration of the user terminal 2A. The user terminal 2A includes a control unit 210A, a storage unit 220A, a communication unit 230A, an input unit 240A, and an output unit 250A. The user terminal 2A is, for example, a general-purpose computer. The storage unit 220A stores various types of information to be referred to by the control unit 210A. The communication unit 230A communicates with a device (information processing apparatus 1A, etc.) outside the user terminal 2A via the communication line N.

### (Input Unit/Output Unit)

The input unit 240A is configured to receive an input to the user terminal 2A, and includes an input device such as a keyboard, a mouse, a touch panel, a camera, and a microphone as an example. The input unit 240A may be configured to receive data from an input device via an interface such as USB, for example. The output unit 250A is configured to perform an output from the user terminal 2A, and includes, as an example, an output device such as a display, a printer, a touch panel, or a speaker. The output unit 250A may be configured to include an interface such as a USB, for example, and may be configured to output data to an output device via the interface.

### (Control Unit)

The control unit 210A includes an application execution unit 21A. The application execution unit 21A is implemented by the control unit 210A reading and executing a command of an application program stored in the storage unit 220A. The application execution unit 21A executes the application program stored in the storage unit 220A, and executes processing of transmitting information indicating the selected rising weight similar product and information indicating the seasonal similar product to the information processing apparatus 1A and processing of displaying a prediction result of sales of a new product. The application implemented by the application execution unit 21A is, for example, a general-purpose web browser, but is not limited thereto. The application execution unit 21A may be a dedicated application for communicating with the information processing apparatus 1A to predict sales of a new product.

The application execution unit 21A includes a reception unit 211A and a display control unit 212A. The reception unit 211A receives user's designation, selection, or the like. The display control unit 212A displays various screens on the display based on the data received from the information processing apparatus 1A.

### Specific Example 1 of New Product Demand Prediction Method

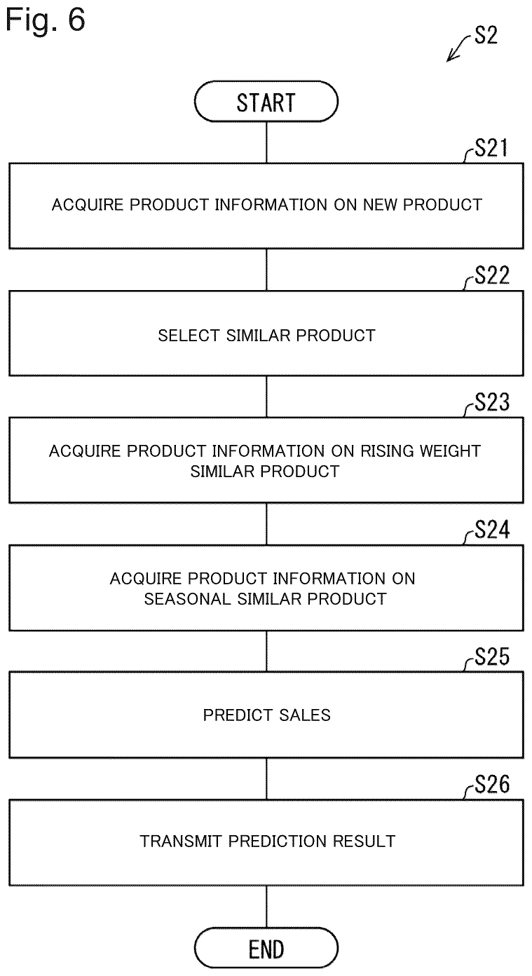

FIG. 6 is a second flowchart illustrating an example of a flow of a new product demand prediction method executed by the demand prediction system 100A. In the example of FIG. 6, a case where the prediction result is displayed on the display of the user terminal 2A will be described. When the user of the user terminal 2A performs an operation for activating an application using the input device, the application execution unit 21A displays a screen for designating or selecting a new product. The user performs an operation of designating or selecting a new product using the input device. The application execution unit 21A transmits data indicating the new product designated or selected by the user to the information processing apparatus 1A. The data includes, for example, identification information for identifying a new product.

### (Step S21)

In step S21, the first acquisition unit 11A of the information processing apparatus 1A acquires product information on a new product. As an example, the first acquisition unit 11A acquires product information on a new product indicated by data received from the user terminal 2A by reading the product information from the database 201.

### (Step S22)

In step S22, the determination unit 15A selects the rising weight similar product and the seasonal similar product from among the plurality of products registered in the database 201. As an example, the determination unit 15A may receive data indicating the rising weight similar product and the seasonal similar product selected by the user from the user terminal 2A, and select the rising weight product and the seasonal similar product based on the received data.

As another example, the determination unit 15A determines the optimum solution in the selection of the rising weight similar product and the seasonal similar product by using the objective function generated in advance by the inverse reinforcement learning based on the decision-making history related to the selection of the rising weight similar product and the seasonal similar product and the product information on the new product acquired by the first acquisition unit 11A, and selects the rising weight similar product and the seasonal similar product based on the determined optimum solution. Details of the processing in which the determination unit 15A determines the optimal solution using the objective function will be described later.

### (Steps S23 and S24)

In step S23, the second acquisition unit 12A acquires the product information on the rising weight similar product selected by the determination unit 15A. In step S24, the third acquisition unit 13A acquires the product information on the seasonal similar product selected by the determination unit 15A.

### (Step S25)

In step S25, the prediction unit 14A predicts the sales of the new product in the predetermined period based on the product information on the new product, the product information on the rising weight similar product, and the product information on the seasonal similar product. More specifically, as an example, the prediction unit 14A predicts the total value of the sales of the new product in the predetermined period using the sales performance of the new product in the promotion period and the rising weight similar product. The prediction unit 14A predicts the sales of the new product for each unit period in the predetermined period by using the total value of the predicted sales and the sales performance of the seasonal similar product for each unit period included in the predetermined period.

### (Step S26)

In step S26, the output control unit 16A transmits data including the prediction result predicted by the prediction unit 14A to the user terminal 2A, and displays the prediction result on the display of the user terminal 2A. As an example, the data may include, in addition to the data indicating the prediction result, product information on a new product, product information on a rising weight similar product, and product information on a seasonal similar product.

### Display Screen Example of Prediction Result

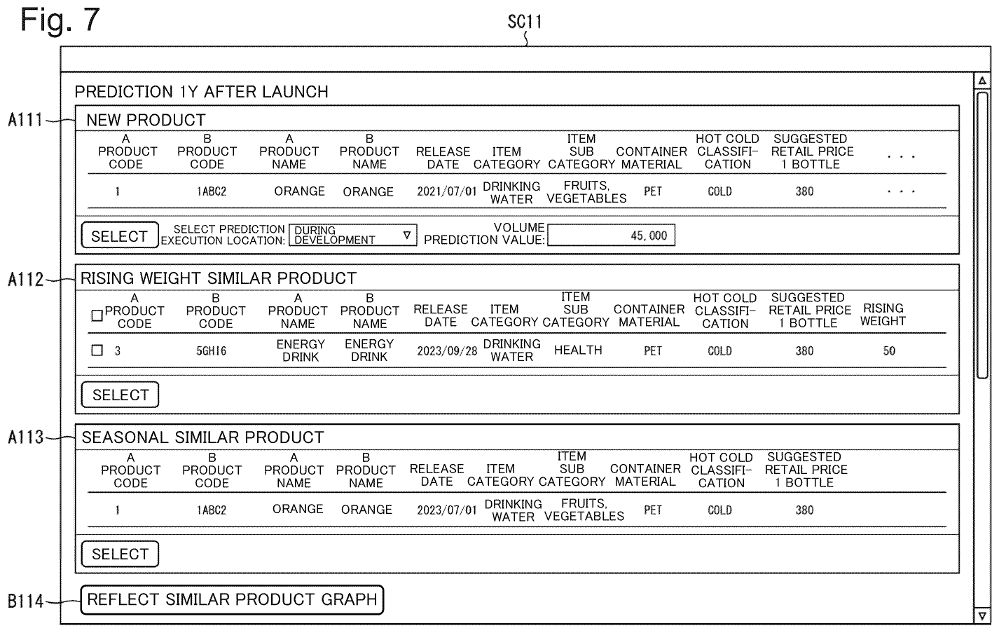

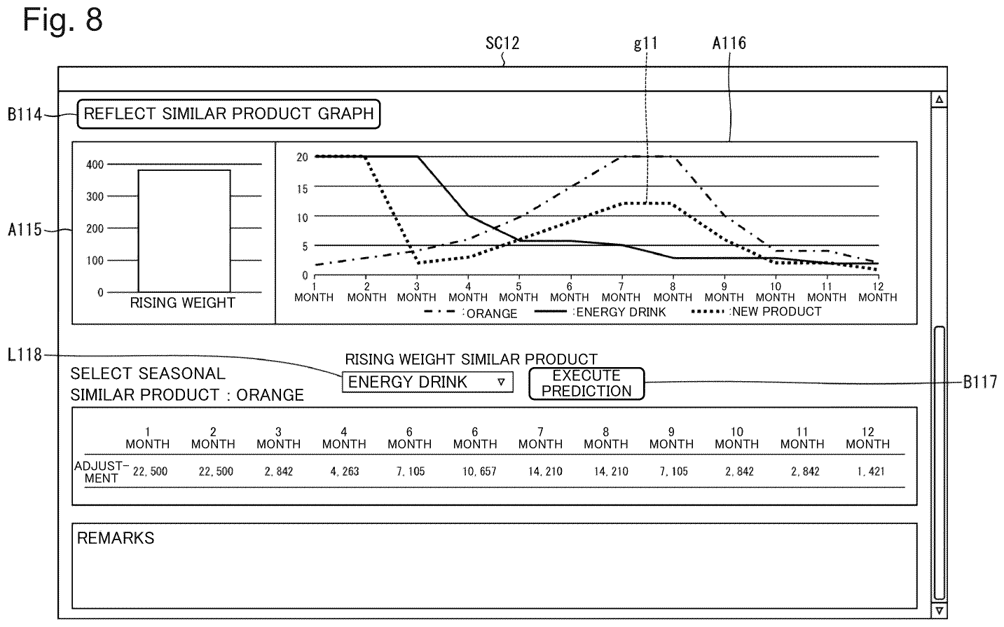

FIGS. 7 and 8 are diagrams illustrating an example of a display screen of a prediction result. A screen SC11 in FIG. 7 and a screen SC12 in FIG. 8 may be displayed as one screen, or may be separately displayed. The screen SC11 in FIG. 7 includes a first display area Alll, a second display area A112, a third display area A113, and a button B114. In the first display area A111, the product information on the new product is displayed. In the second display area A112, the product information on the rising weight similar product is displayed. The third display area A113 displays product information on the seasonal similar product.

The button B114 is a button for displaying a sales prediction result based on the selected similar product.

The user of the demand prediction system 100A performs an operation of selecting the rising weight similar product and the seasonal similar product and selecting the button B114 on the screen of FIG. 7. When the button B114 is selected by the user, the display control unit 212A displays the prediction result on the display.

As an example, the screen SC12 of FIG. 8 is displayed below the screen SC11 of FIG. 7 when the button B114 is selected. The screen SC12 includes a button B114, a rising weight display area A115, a graph display area A116, a button B117, and an adjustment area A118. In the rising weight display area A115, a bar graph representing the rising weight of the rising weight similar product is displayed.

In the graph display area A116, a graph representing a prediction result of sales of a new product is displayed. In a graph displayed in the graph display area A116, the horizontal axis represents a period elapsed from release, and the vertical axis represents sales performance or sales prediction. In the example of FIG. 8, a monthly sales prediction value of a line graph g11 indicating the sales prediction of the new product is a value calculated by the prediction unit 14A using the rising weight of the selected rising weight similar product and the monthly sales performance of the selected seasonal similar product. Therefore, as illustrated in FIG. 8, the fluctuation pattern of the sales prediction of the new product in the predetermined period (one year) has a correlation with the fluctuation pattern of the sales performance of the seasonal similar product in the predetermined period.

A pull-down list L118 is a pull-down list for selecting a category of a rising weight similar product. When the user selects a category from the pull-down list L118, the display control unit 212A displays information on products belonging to the selected category in the second display area A112. In the adjustment area A118, a table representing the monthly sales prediction result of the new product is displayed. The user can correct the predicted value of sales for each month displayed in the adjustment area A118 using the input unit 240A. The button B117 is a button for reflecting the corrected prediction value in the prediction result. When the button B117 is selected, the application execution unit 21A displays a graph reflecting the corrected sales value in the graph display area A116.

### (Selection of Similar Product Based on Past Decision-Making History)

Details of processing in a case where the determination unit 15A selects a similar product based on a decision-making history related to selection of a rising weight similar product and a seasonal similar product will be described. In this case, the determination unit 15A determines an optimum solution related to selection of a similar product using an objective function generated in advance. The objective function is generated in advance by the inverse reinforcement learning based on the decision-making history related to the selection of the rising weight similar product and the seasonal similar product.

The decision-making history includes, for example, state data on a new product and behavioral data on a selected similar product. The state data on the new product includes, for example, product information on the new product, measure information indicating measures targeted for the new product, external environmental information (temperature, etc.) at the time of release of the new product, and the like. The behavioral data on the selected similar product includes, for example, product information on the selected similar product, measure information indicating measures targeted for the similar product, external environmental information (temperature, etc.) at the time of release of the similar product, and the like. These pieces of data are stored in the database 201 as an example.

The objective function is expressed by the following Expression (1) as an example.

f(x)=λ₁x₁+λ₂x₂+λ₃x₃+. . . +λₙxₙ (1)

In Expression (1), xᵢ (i=1, 2, . . . , n) is an explanatory variable, and n is the total number of explanatory variables. The explanatory variables x₁, x₂, . . . , and xₙ are data associated with each item included in the state data or the behavioral data. λᵢ is a weighting factor.

The generation of the objective function is performed by the generation unit 17A as an example. In this case, the generation unit 17A generates an objective function by inverse reinforcement learning using a past decision-making history. More specifically, as an example, the generation unit 17A generates the objective function by determining the weighting factor λᵢ (i=1, 2, . . . , n) of the above-described Expression (1) by inverse reinforcement learning using a set of state data and behavioral data that is a history of past decision-making. The weighting factor λᵢ is an index indicating how much the item associated with each explanatory variable is emphasized, and can be said to reflect the intention of the user who has made a past decision.

The determination unit 15A selects a similar product using the product information on the new product and the objective function. More specifically, as an example, the determination unit 15A determines the optimum solution in the selection of the similar product using the product information on the new product and the objective function of Expression (1).

### Specific Example 2 of New Product Demand Prediction Method

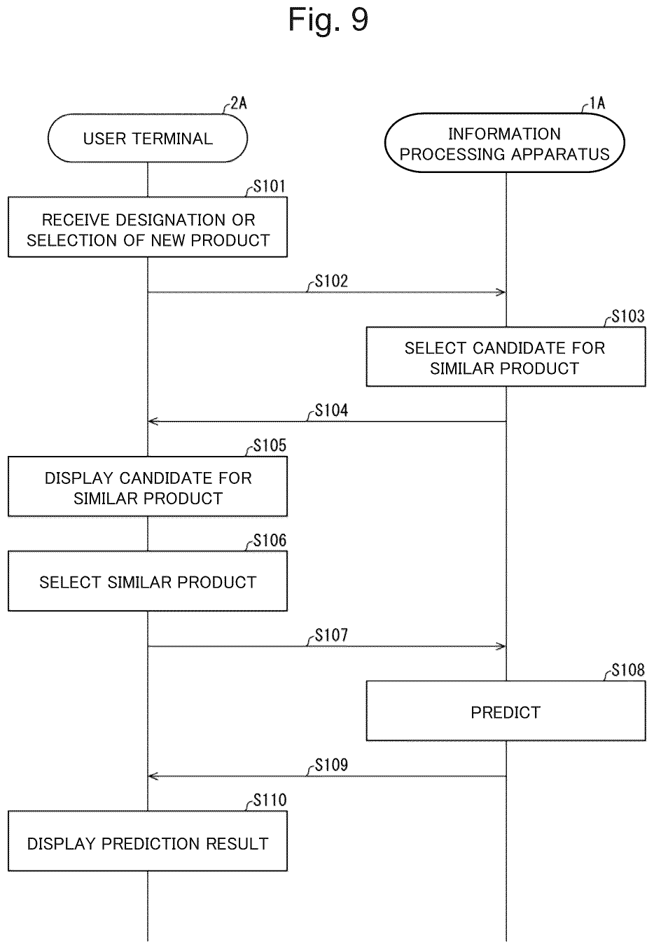

FIG. 9 is a sequence diagram illustrating a third example of the flow of the new product demand prediction method executed by the demand prediction system 100A. In this example, the determination unit 15A of the information processing apparatus 1A presents a plurality of candidates for similar products to the user, and the prediction unit 14A predicts sales of a new product using a similar product selected from among the plurality of candidates presented.

When the user of the user terminal 2A performs an operation for activating the application using the input device, in step S101, the application execution unit 21A displays a screen for receiving designation or selection of a new product, and receives the designation or selection of the new product on the screen. When the designation or selection of the new product by the user is received, in step S102, the application execution unit 21A transmits information indicating the new product to the information processing apparatus 1A.

In step S103, the determination unit 15A selects a similar product candidate. As an example, the determination unit 15A selects a similar product candidate by solving an optimal solution using product information on a new product and the above-described objective function. In step S104, the determination unit 15A transmits data indicating the selected similar product candidate to the user terminal 2A. At this time, the output control unit 16A may output a weighting factor included in the objective function used to select the similar product candidate in addition to the data indicating the similar product candidate.

In step S105, the application execution unit 21A displays the similar product candidates on the display based on the received data. At this time, the application execution unit 21A may display the weighting factor included in the objective function used to select the similar product candidate on the display based on the received data. The user performs an operation of selecting a rising weight similar product and a seasonal similar product from among the displayed similar product candidates. In step S106, the application execution unit 21A selects the rising weight similar product and the seasonal similar product based on the user operation. In step S107, the application execution unit 21A transmits data indicating the selected rising weight similar product and seasonal similar product to the information processing apparatus 1A.

In step S108, the prediction unit 14A predicts the sales of the new product in the predetermined period using the product information on the new product, the product information on the rising weight similar product, and the product information on the seasonal similar product. In step S109, the output control unit 16A transmits data indicating the prediction result to the user terminal 2A. At this time, the output control unit 16A may output the weighting factor included in the objective function used to select the similar product in addition to the data indicating the prediction result. In step S110, the display control unit 212A displays a screen indicating the prediction result (screen exemplified in FIG. 8, and the like) on the display based on the data received from the information processing apparatus 1A. At this time, the display control unit 212A may display the weighting factor included in the objective function on the display in addition to the prediction result.

### (Effects of Information Processing Apparatus)

As described above, in the information processing apparatus 1A, the prediction unit 14A predicts the total value of the sales of the new product in the predetermined period by using the sales performance of the new product in the promotion period and the ratio of the sales performance of the rising weight similar product in the promotion period to the sales performance of the rising weight similar product in the predetermined period, and predicts the sales of the new product in each unit period in the predetermined period by using the predicted total value of the sales and the sales performance of each unit period (for example, monthly) included in the predetermined period of the seasonal similar product.

As described above, the rising weight similar product is a product selected as a similar product from the viewpoint of similarity of the rising weight, and the seasonal similar product is a product selected as a similar product from the viewpoint of similarity of the demand fluctuation pattern. As described above, by selecting two types of similar products with different viewpoints and predicting the sales of new products using both the rising weight of the rising weight similar product and the sales performance of the seasonal similar product per unit period, it is possible to more accurately predict the long-term demand for new products that have passed the promotion period.

The information processing apparatus 1A further includes a determination unit 15A that determines an optimum solution in selection of a rising weight similar product and a seasonal similar product by using an objective function generated in advance by inverse reinforcement learning based on a decision-making history related to selection of the rising weight similar product and the product information on the new product acquired by the first acquisition unit 11A. The second acquisition unit 12A acquires the product information on the rising weight similar product based on the optimum solution determined by the determination unit 15A, and the third acquisition unit 13A acquires the product information on the seasonal similar product based on the optimum solution determined by the determination unit 15A. Therefore, according to the information processing apparatus 1A, it is possible to easily select the rising weight similar product and the seasonal similar product.

The information processing apparatus 1A is configured to include a generation unit 17A that generates an objective function for determining an optimal solution in selection of a rising weight similar product and a seasonal similar product by inverse reinforcement learning based on a decision-making history regarding selection of a rising weight similar product and a seasonal similar product. By using the objective function generated by the generation unit 17A, it is possible to easily select the rising weight similar product and the seasonal similar product.

The information processing apparatus 1A employs a configuration including an output control unit 16A that outputs a prediction result of sales of a new product. Therefore, according to the information processing apparatus 1A, the user can easily grasp the prediction result of the sales of the new product.

The information processing apparatus 1A includes the output control unit 16A that presents the plurality of candidates for the rising weight similar product and the plurality of candidates for the seasonal similar product to the user based on the optimum solution determined by the determination unit 15A. The second acquisition unit 12A acquires the product information on the product selected from the plurality of candidates for the rising weight similar product based on the user operation, and the third acquisition unit 13A acquires the product information on the product selected from the plurality of candidates for the seasonal similar product based on the user operation. Therefore, according to the information processing apparatus 1A, it is possible to easily select a similar product reflecting the intention of the user.

The information processing apparatus 1A includes the second acquisition unit 12A acquires product information indicating sales performance of a plurality of rising weight similar products, the third acquisition unit 13A acquires product information indicating sales performance of a plurality of seasonal similar products, and the prediction unit 14A predicts sales of a new product in a predetermined period based on statistical values of sales performance of a plurality of rising weight similar products and statistical values of sales performance of a plurality of seasonal similar products. Therefore, according to the information processing apparatus 1A, long-term demand prediction of a new product that has passed the promotion period can be accurately performed.

### Example of Implementation by Software

Some or all of the functions of the new product demand prediction apparatus 1, the information processing apparatus 1A, and the user terminal 2A (hereinafter, also referred to as “each of the above devices”) may be achieved by hardware such as an integrated circuit (IC chip) or may be achieved by software.

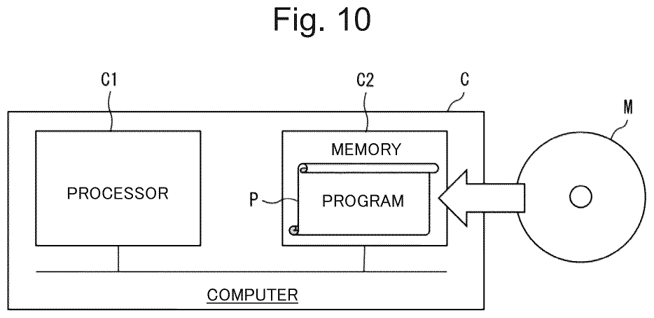

In the latter case, each of the above apparatuses is implemented by, for example, a computer that executes a command of a program which is software for implementing each function. An example of such a computer (hereinafter, referred to as a computer C) is illustrated in FIG. 10. FIG. 10 is a block diagram illustrating a hardware configuration of a computer C functioning as each of the above apparatuses.

The computer C includes at least one processor C1 and at least one memory C2. A program P causing the computer C to operate as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from another apparatus. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

The demand prediction for new products often mainly targets several months after release, such as a promotion target period. On the other hand, a past performance for at least one year is required for time series prediction predicted from a past level, trend, and seasonality as existing products. Therefore, demand prediction for a period from the promotion target period to the elapse of one year tends to be personal, and there is a problem that prediction accuracy is lowered. As a result, for example, the probability of occurrence of shortage or excess stock increases.

The present disclosure has been made in view of the above problems, and an exemplary object thereof is to provide a technology capable of accurately performing long-term demand prediction of a new product that has passed a promotion period.

### [Supplementary Note 1]

The present disclosure includes techniques described in the following supplementary notes. However, the present disclosure is not limited to the techniques described in the following supplementary note, and various modifications can be made within the scope described in the claims.

### [Supplementary Note A]

The present disclosure includes techniques described in the following supplementary notes. However, the present disclosure is not limited to the techniques described in the following supplementary note, and various modifications can be made within the scope described in the claims.

### (Supplementary Note A1)

A new product demand prediction apparatus including:
first acquisition means for acquiring new product information including at least information regarding promotion of a new product that is a target of demand prediction;
second acquisition means for acquiring first similar product information indicating a sales performance of a first similar product selected based on at least one element of a scale of the promotion, a characteristic of a product, and a sales method;
third acquisition means for acquiring second similar product information indicating a sales performance of a second similar product selected based on the category of the product; and
prediction means for predicting sales in a predetermined period including a period after a promotion period of the new product based on the new product information, the first similar product information, and the second similar product information.

### (Supplementary Note A2)

The new product demand prediction apparatus according to Supplementary Note A1, in which the prediction means
predicts a total value of sales of the new product during the predetermined period by using sales performance of the new product during the promotion period and a ratio of the sales performance of the first similar product during the promotion period to the sales performance of the first similar product during the predetermined period, and
predicts sales of the new product for each unit period in the predetermined period using the total value of the sales and a sales performance of the second similar product for each unit period included in the predetermined period.

### (Supplementary Note A3)

The new product demand prediction apparatus according to Supplementary Note A1 or A2, further including determination means for determining an optimum solution in selection of the first similar product and the second similar product by using an objective function generated in advance by inverse reinforcement learning based on a decision-making history related to selection of the first similar product and the second similar product and the new product information acquired by the first acquisition means, in which
the second acquisition means acquires the first similar product information based on the optimum solution determined by the determination means, and
the third acquisition means acquires the second similar product information based on the optimum solution determined by the determination means.

### (Supplementary Note A4)

The new product demand prediction apparatus according to Supplementary Note A3, further including generation means for generating an objective function for determining an optimum solution in selection of the first similar product and the second similar product by inverse reinforcement learning based on a decision-making history related to selection of the first similar product and the second similar product.

### (Supplementary Note A5)

The new product demand prediction apparatus according to any one of Supplementary Notes A1 to A4, further including output control means for outputting a prediction result of the sales.

### (Supplementary Note A6)

The new product demand prediction apparatus according to Supplementary Note A3 or A4, further including presentation means for presenting a plurality of candidates for the first similar product and a plurality of candidates for the second similar product to a user based on the optimum solution determined by the determination means, in which
the second acquisition means acquires first similar product information on the first similar product selected from the plurality of candidates for the first similar product based on a user operation, and
the third acquisition means acquires second similar product information on the second similar product selected from the plurality of candidates for the second similar product based on the user operation.

### (Supplementary Note A7)

The new product demand prediction apparatus according to any one of Supplementary Notes A1 to A6, in which
the second acquisition means acquires first similar product information indicating sales performance of the plurality of first similar products,
the third acquisition means acquires second similar product information indicating sales performance of the plurality of second similar products, and
the prediction means predicts sales of the new product in the predetermined period based on a statistical value of sales performance for each of the first similar products indicated by the first similar product information and a statistical value of sales performance for each of the second similar products indicated by the second similar product information.

### [Supplementary Note B]

The present disclosure includes techniques described in the following supplementary notes. However, the present disclosure is not limited to the techniques described in the following supplementary note, and various modifications can be made within the scope described in the claims.

### (Supplementary Note B1)

A new product demand prediction method including:
by at least one processor,
first acquisition processing for acquiring new product information including at least information regarding promotion of a new product that is a target of demand prediction;
second acquisition processing for acquiring first similar product information indicating a sales performance of a first similar product selected based on at least one element of a scale of the promotion, a characteristic of a product, and a sales method;
third acquisition processing for acquiring second similar product information indicating a sales performance of a second similar product selected based on the category of the product; and
prediction processing for predicting sales in a predetermined period including a period after a promotion period of the new product based on the new product information, the first similar product information, and the second similar product information.

### (Supplementary Note B2)

The new product demand prediction method according to Supplementary Note B1, in which in the prediction processing, the at least one processor predicts a total value of sales of the new product during the predetermined period by using sales performance of the new product during the promotion period and a ratio of the sales performance of the first similar product during the promotion period to the sales performance of the first similar product during the predetermined period, and predicts sales of the new product for each unit period in the predetermined period using the total value of the sales and a sales performance of the second similar product for each unit period included in the predetermined period.

### (Supplementary Note B3)

The new product demand prediction method according to Supplementary Note B1 or B2, in which the at least one processor further includes determination processing for determining an optimum solution in selection of the first similar product and the second similar product by using an objective function generated in advance by inverse reinforcement learning based on a decision-making history related to selection of the first similar product and the second similar product and the new product information acquired by the first acquisition processing,
in the second acquisition processing, the at least one processor acquires the first similar product information based on the optimum solution determined by the determination processing, and
in the third acquisition processing, the at least one processor acquires the second similar product information based on the optimum solution determined by the determination processing.

### (Supplementary Note B4)

The new product demand prediction method according to Supplementary Note B3, in which the at least one processor further includes generation processing for generating an objective function for determining an optimum solution in selection of the first similar product and the second similar product by inverse reinforcement learning based on a decision-making history related to selection of the first similar product and the second similar product.

### (Supplementary Note B5)

The new product demand prediction method according to any one of Supplementary Notes B1 to B4, in which the at least one processor further includes output control processing for outputting a prediction result of the sales.

### (Supplementary Note B6)

The new product demand prediction method according to Supplementary Note B3 or B4, in which the at least one processor further includes presentation processing for presenting a plurality of candidates for the first similar product and a plurality of candidates for the second similar product to a user based on the optimum solution determined by the determination processing,
in the second acquisition processing, the at least one processor acquires first similar product information on the first similar product selected from the plurality of candidates for the first similar product based on a user operation, and
in the third acquisition processing, the at least one processor acquires second similar product information on the second similar product selected from the plurality of candidates for the second similar product based on the user operation.

### (Supplementary Note B7)

The new product demand prediction method according to any one of Supplementary Notes B1 to B6, in which
in the second acquisition processing, the at least one processor acquires first similar product information indicating sales performance of the plurality of first similar products,
in the third acquisition processing, the at least one processor acquires second similar product information indicating sales performance of the plurality of second similar products, and
in the prediction processing, the at least one processor predicts sales of the new product in the predetermined period based on a statistical value of sales performance for each of the first similar products indicated by the first similar product information and a statistical value of sales performance for each of the second similar products indicated by the second similar product information.

### [Supplementary Note C]

The present disclosure includes techniques described in the following supplementary notes. However, the present disclosure is not limited to the techniques described in the following supplementary note, and various modifications can be made within the scope described in the claims.

### (Supplementary Note C1)

A new product demand prediction program causing a computer to function as a new product demand prediction apparatus, causing the computer to function as:
first acquisition means for acquiring new product information including at least information regarding promotion of a new product that is a target of demand prediction;
second acquisition means for acquiring first similar product information indicating a sales performance of a first similar product selected based on at least one element of a scale of the promotion, a characteristic of a product, and a sales method;
third acquisition means for acquiring second similar product information indicating a sales performance of a second similar product selected based on the category of the product; and
prediction means for predicting sales in a predetermined period including a period after a promotion period of the new product based on the new product information, the first similar product information, and the second similar product information.

### (Supplementary Note C2)

The new product demand prediction program according to Supplementary Note C1, in which the prediction means
predicts a total value of sales of the new product during the predetermined period by using sales performance of the new product during the promotion period and a ratio of the sales performance of the first similar product during the promotion period to the sales performance of the first similar product during the predetermined period, and
predicts sales of the new product for each unit period in the predetermined period using the total value of the sales and a sales performance of the second similar product for each unit period included in the predetermined period.

### (Supplementary Note C3)

The new product demand prediction program according to Supplementary Note C1 or C2, further causing the computer to function as determination means for determining an optimum solution in selection of the first similar product and the second similar product by using an objective function generated in advance by inverse reinforcement learning based on a decision-making history related to selection of the first similar product and the second similar product and the new product information acquired by the first acquisition means, in which
the second acquisition means acquires the first similar product information based on the optimum solution determined by the determination means, and
the third acquisition means acquires the second similar product information based on the optimum solution determined by the determination means.

### (Supplementary Note C4)

The new product demand prediction program according to Supplementary Note C3, further causing the computer to function as generation means for generating an objective function for determining an optimum solution in selection of the first similar product and the second similar product by inverse reinforcement learning based on a decision-making history related to selection of the first similar product and the second similar product.

### (Supplementary Note C5)

The new product demand prediction program according to any one of Supplementary Notes C1 to C4, further causing the computer to function as output control means for outputting a prediction result of the sales.

### (Supplementary Note C6)

The new product demand prediction program according to Supplementary Note C3 or C4, further causing the computer to function as presentation means for presenting a plurality of candidates for the first similar product and a plurality of candidates for the second similar product to a user based on the optimum solution determined by the determination means, in which
the second acquisition means acquires first similar product information on the first similar product selected from the plurality of candidates for the first similar product based on a user operation, and
the third acquisition means acquires second similar product information on the second similar product selected from the plurality of candidates for the second similar product based on the user operation.

### (Supplementary Note C7)

The new product demand prediction program according to any one of Supplementary Notes C1 to C6, in which
the second acquisition means acquires first similar product information indicating sales performance of the plurality of first similar products,
the third acquisition means acquires second similar product information indicating sales performance of the plurality of second similar products, and
the prediction means predicts sales of the new product in the predetermined period based on a statistical value of sales performance for each of the first similar products indicated by the first similar product information and a statistical value of sales performance for each of the second similar products indicated by the second similar product information.

### [Supplementary Note D]

The present disclosure includes techniques described in the following supplementary notes. However, the present disclosure is not limited to the techniques described in the following supplementary note, and various modifications can be made within the scope described in the claims.

### (Supplementary Note D1)

A new product demand prediction apparatus including at least one processor, the at least one processor executing:
first acquisition processing for acquiring new product information including at least information regarding promotion of a new product that is a target of demand prediction;
second acquisition processing for acquiring first similar product information indicating a sales performance of a first similar product selected based on at least one element of a scale of the promotion, a characteristic of a product, and a sales method;
third acquisition processing for acquiring second similar product information indicating a sales performance of a second similar product selected based on the category of the product; and
prediction processing for predicting sales in a predetermined period including a period after a promotion period of the new product based on the new product information, the first similar product information, and the second similar product information.

The new product demand prediction apparatus may further include a memory. The memory may store a program for causing the at least one processor to execute each of the processing.

### (Supplementary Note D2)

The new product demand prediction apparatus according to Supplementary Note D1, in which in the prediction processing, the at least one processor
predicts a total value of sales of the new product during the predetermined period by using sales performance of the new product during the promotion period and a ratio of the sales performance of the first similar product during the promotion period to the sales performance of the first similar product during the predetermined period, and
predicts sales of the new product for each unit period in the predetermined period using the total value of the sales and a sales performance of the second similar product for each unit period included in the predetermined period.

### (Supplementary Note D3)

The new product demand prediction apparatus according to Supplementary Note D1 or D2, in which the at least one processor further executes determination processing for determining an optimum solution in selection of the first similar product and the second similar product by using an objective function generated in advance by inverse reinforcement learning based on a decision-making history related to selection of the first similar product and the second similar product and the new product information acquired by the first acquisition processing,
in the second acquisition processing, the at least one processor acquires the first similar product information based on the optimum solution determined by the determination processing, and
in the third acquisition processing, the at least one processor acquires the second similar product information based on the optimum solution determined by the determination processing.

### (Supplementary Note D4)

The new product demand prediction apparatus according to Supplementary Note D3, in which the at least one processor further includes generation processing for generating an objective function for determining an optimum solution in selection of the first similar product and the second similar product by inverse reinforcement learning based on a decision-making history related to selection of the first similar product and the second similar product.

### (Supplementary Note D5)

The new product demand prediction apparatus according to any one of Supplementary Notes D1 to D4, in which the at least one processor further executes output control processing for outputting a prediction result of the sales.

### (Supplementary Note D6)

The new product demand prediction apparatus according to Supplementary Note D3 or D4, in which the at least one processor further executes presentation processing for presenting a plurality of candidates for the first similar product and a plurality of candidates for the second similar product to a user based on the optimum solution determined by the determination processing,
in the second acquisition processing, the at least one processor acquires first similar product information on the first similar product selected from the plurality of candidates for the first similar product based on a user operation, and
in the third acquisition processing, the at least one processor acquires second similar product information on the second similar product selected from the plurality of candidates for the second similar product based on the user operation.

### (Supplementary Note D7)

The new product demand prediction apparatus according to any one of Supplementary Notes D1 to D6, in which
in the second acquisition processing, the at least one processor acquires first similar product information indicating sales performance of the plurality of first similar products,
in the third acquisition processing, the at least one processor acquires second similar product information indicating sales performance of the plurality of second similar products, and
in the prediction processing, the at least one processor predicts sales of the new product in the predetermined period based on a statistical value of sales performance for each of the first similar products indicated by the first similar product information and a statistical value of sales performance for each of the second similar products indicated by the second similar product information.

### [Supplementary Note E]

The present disclosure includes techniques described in the following supplementary notes. However, the present disclosure is not limited to the techniques described in the following supplementary note, and various modifications can be made within the scope described in the claims.

### (Supplementary Note E1)

A non-transitory recording medium recording a new product demand prediction program for causing a computer to function as a new product demand prediction apparatus, causing the computer to execute:
first acquisition processing of acquiring new product information including at least information regarding promotion of a new product that is a target of demand prediction;
second acquisition processing of acquiring first similar product information indicating a sales performance of a first similar product selected based on at least one element of a scale of a promotion, a characteristic of a product, and a sales method;
third acquisition processing of acquiring second similar product information indicating a sales performance of a second similar product selected based on a category of a product; and
prediction processing of predicting sales in a predetermined period including a period after a promotion period of the new product based on the new product information, the first similar product information, and the second similar product information.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims.

1. A new product demand prediction apparatus comprising:
a memory configured to store instructions; and
one or more processors configured to execute the instructions to:
acquire new product information including at least information regarding promotion of a new product that is a target of demand prediction;
acquire first similar product information indicating a sales performance of a first similar product selected based on at least one element of a scale of the promotion, a characteristic of a product, and a sales method;
acquire second similar product information indicating a sales performance of a second similar product selected based on the category of the product; and
predict sales in a predetermined period including a period after a promotion period of the new product based on the new product information, the first similar product information, and the second similar product information.

2. The new product demand prediction apparatus according to claim 1, wherein
the one or more processors are further configured to execute the instructions to:
predict a total value of sales of the new product during the predetermined period by using sales performance of the new product during the promotion period and a ratio of the sales performance of the first similar product during the promotion period to the sales performance of the first similar product during the predetermined period; and
predict sales of the new product for each unit period in the predetermined period by using the total value of the sales and a sales performance of the second similar product for each unit period included in the predetermined period.

3. The new product demand prediction apparatus according to claim 1, wherein
the one or more processors are further configured to execute the instructions to:
determine an optimum solution in selection of the first similar product and the second similar product by using an objective function generated in advance by inverse reinforcement learning based on a decision-making history related to selection of the first similar product and the second similar product and the new product information;
acquire the first similar product information based on the determined optimum solution; and
acquire the second similar product information based on the determined optimum solution determined.

4. The new product demand prediction apparatus according to claim 3, wherein
the one or more processors are further configured to execute the instructions to:
generate an objective function for determining an optimum solution in selection of the first similar product and the second similar product by inverse reinforcement learning based on a decision-making history related to selection of the first similar product and the second similar product.

5. The new product demand prediction apparatus according to claim 1, wherein
the one or more processors are further configured to execute the instructions to:
output a prediction result of the sales.

6. The new product demand prediction apparatus according to claim 3, wherein
the one or more processors are further configured to execute the instructions to:
present a plurality of candidates for the first similar product and a plurality of candidates for the second similar product to a user based on the determined optimum solution;
acquire first similar product information on the first similar product selected from the plurality of candidates for the first similar product based on a user operation; and
acquire second similar product information on the second similar product selected from the plurality of candidates for the second similar product based on the user operation.

7. The new product demand prediction apparatus according to claim 1, wherein
the one or more processors are further configured to execute the instructions to:
acquire first similar product information indicating sales performance of a plurality of the first similar products;
acquire second similar product information indicating sales performance of a plurality of the second similar products; and
predict sales of the new product in the predetermined period based on a statistical value of sales performance for each of the first similar products indicated by the first similar product information and a statistical value of sales performance for each of the second similar products indicated by the second similar product information.

8. A new product demand prediction method comprising:
acquiring new product information including at least information regarding promotion of a new product that is a target of demand prediction;
acquiring first similar product information indicating a sales performance of a first similar product selected based on at least one element of a scale of the promotion, a characteristic of a product, and a sales method;
acquiring second similar product information indicating a sales performance of a second similar product selected based on the category of the product; and
predicting sales in a predetermined period including a period after a promotion period of the new product based on the new product information, the first similar product information, and the second similar product information.

9. A non-transitory computer-readable recording medium recording a program for causing a computer to execute the steps of:
acquiring new product information including at least information regarding promotion of a new product that is a target of demand prediction;
acquiring first similar product information indicating a sales performance of a first similar product selected based on at least one element of a scale of the promotion, a characteristic of a product, and a sales method;
acquiring second similar product information indicating a sales performance of a second similar product selected based on the category of the product; and
predicting sales in a predetermined period including a period after a promotion period of the new product based on the new product information, the first similar product information, and the second similar product information.
